(19) United States
(12) Patent Application Publication
(10) Pub. No.: US 2021/0146945 A1
(43) Pub. Date: May 20, 2021

(54) METHOD OF CALCULATING STOPPING DISTANCE AND RELATED DEVICES

(71) Applicant: Continental Automotive Systems, Inc., Auburn Hills, MI (US)

(72) Inventors: Arthur Brown, Sterling Heights, MI (US); John Brandow, Clinton Township, MI (US); Aron Cruce, Rochester Hills, MI (US); Susan Drescher, Bloomfield Hills, MI (US); Harish Patel, Shelby Township, MI (US)

(73) Assignee: Continental Automotive Systems, Inc., Auburn Hills, MI (US)

(21) Appl. No.: 16/685,966

(22) Filed: Nov. 15, 2019

(51) Int. Cl. B60W 50/14; B60W 40/105; B60W 40/06; B60K 35/00

(52) U.S. Cl. CPC B60W 50/14; B60W 40/105; B60W 40/06; B60K 35/00; B60W 2520/04; B60K 2370/1529; B60K 2370/177; B60W 2550/12; B60W 2050/146

(57) ABSTRACT

A method of calculating a stopping distance for a vehicle, where the method includes collecting real time data from vehicle onboard sensors, collecting real time data from connected network data, estimating a stopping distance of the vehicle based on the data from vehicle onboard sensors and data from connected network data, and communicating the stopping distance to an operator of the vehicle including visualizing the stopping distance to the operator of the vehicle.

### TECHNICAL FIELD

The disclosure herein relates to a method of calculating and visualizing stopping distance.

### TECHNICAL BACKGROUND

The amount of stopping distance required for a vehicle in a given situation is not information that is normally communicated to drivers. Typically, a driver must estimate how much stopping distance is necessary based on experience and/or training. The driver also may implement a technique of a safe following distance relative to other vehicles. Drivers may be mistaken in the amount of necessary stopping distance. In addition, many drivers fail to consistently apply safe following distance techniques. Still further, mechanical and environmental factors, which vary widely by vehicle or locations, greatly influence the amount of necessary stopping distance and accordingly may not be appropriately accommodated by the driver.

What is needed is a better way to calculate stopping distance and to calculate the information to the driver using real-time conditions.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In one or more embodiments, a method of calculating a stopping distance for a vehicle and displaying the stopping distance, the method including: collecting vehicle real time data from vehicle onboard sensors; collecting network real time data from connected network data; estimating stopping distance of the vehicle based on the vehicle real time data from vehicle onboard sensors and data from connected network data; and communicating the stopping distance to an operator of the vehicle including visualizing the stopping distance to the operator of the vehicle. Other embodiments include corresponding computer systems, apparatus, and computer programs recorded on one or more computer storage devices, each configured to perform the actions of the methods.

Implementations may include one or more of the following features. The method as recited where visualizing the stopping distance to the operator of the vehicle includes visualizing using a heads up display (HUD). The method as recited where visualizing the stopping distance to the operator of the vehicle includes visualizing using an augmented reality heads up display (AR HUD). The method as recited where visualizing the stopping distance to the operator of the vehicle includes indicating the stopping distance with a brake box graphic. The method as recited where the brake box graphic is adjusted in real-time.

The method as recited where collecting vehicle real time data from vehicle onboard sensors includes collecting vehicle speed data. The method as recited where collecting vehicle real time data from vehicle onboard sensors includes collecting tire type data. The method as recited where collecting vehicle real time data from vehicle onboard sensors includes collecting tire condition data. The method as recited where collecting vehicle real time data from vehicle onboard sensors includes collecting environmental temperature data. The method as recited where collecting vehicle real time data from vehicle onboard sensors includes collecting weather condition data. The method as recited where collecting vehicle real time data from vehicle onboard sensors includes collecting road grade data. The method as recited where collecting vehicle real time data from vehicle onboard sensors includes collecting brake condition data. Implementations of the described techniques may include hardware, a method or process, or computer software on a computer-accessible medium.

In one or more embodiments, an apparatus for calculating and displaying stopping distance for a vehicle, the apparatus including: vehicle onboard sensors configured to generate vehicle real time data; a connected network configured to generate real time network data; a processor configured to estimate a stopping distance of the vehicle based on the vehicle real time data and the real time network data; and a stopping distance indicator communicatively coupled with the processor, the stopping distance indicator configured to visualize the stopping distance to an operator of the vehicle. Other embodiments include corresponding computer systems, apparatus, and computer programs recorded on one or more computer storage devices, each configured to perform the actions of the methods.

Implementations may include one or more of the following features. The apparatus as recited where the vehicle real time data includes vehicle speed data. The apparatus as recited where the vehicle real time data includes at least one of tire condition data, tire type data, or road grade data. The apparatus as recited where the vehicle real time data includes at least one of environmental temperature data or weather condition data. The apparatus as recited where the vehicle real time data includes brake condition data. Implementations of the described techniques may include hardware, a method or process, or computer software on a computer-accessible medium.

### BRIEF DESCRIPTION OF THE DRAWINGS

FIG. 1 illustrates a system diagram of the apparatus, as constructed in accordance with one or more embodiments.

FIG. 2 illustrates visualization of the stopping distance to an operator of the vehicle, as constructed in accordance with one or more embodiments.

FIG. 3 illustrates visualization of the stopping distance to an operator of the vehicle, as constructed in accordance with one or more embodiments.

FIG. 4 illustrates a diagram of the method, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by the instrumentalities, procedures, and combinations pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

A system of one or more computers can be configured to perform particular operations or actions by virtue of having software with algorithms, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The system collects data from real-time telemetric and system data from the vehicle's onboard sensors as well as available connected network data. Real time data could be used to determine a more accurate braking distance requirement. Data sources include, but are not limited to, vehicle speed, tire type, tire condition, tire temperature, environment temperature (exterior to the vehicle), weather, road condition, road grade, and brake condition.

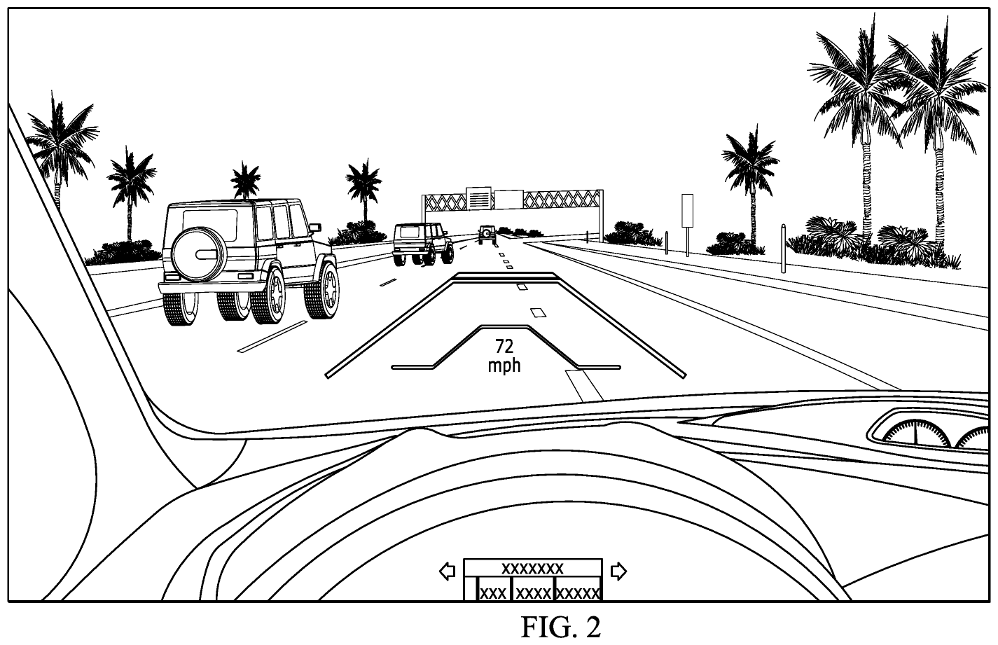

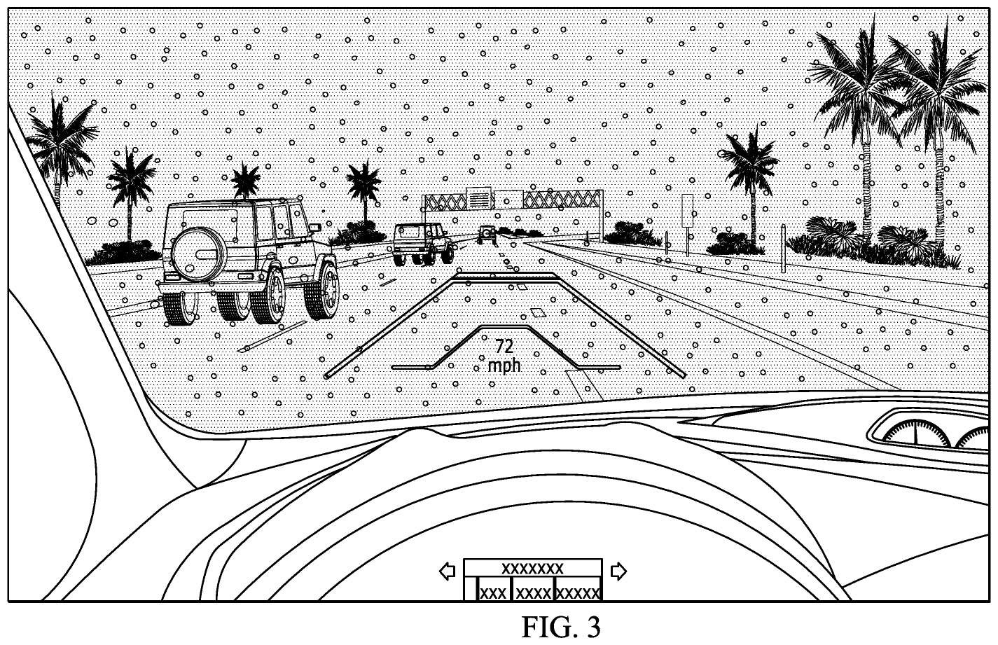

The available real-time data is used in an algorithm to obtain a braking distance requirement. The required braking distance at any given time would be visualized to the operator for a vehicle, for example with a heads up display (HUD) or augmented reality heads up display (AR HUD). In one or more embodiments, the braking distance is indicated with a graphic or line art representation on the roadway in the driver's field of view (FIGS. 2-3).

The visualization would offer an ongoing visual indicator of safe braking distance that the driver could use to improve their driving habits and safety. The system or apparatus improves the operator's awareness of the vehicle's optimum performance for the current conditions. For example, operator would see the brake box lengthen during driving in rainy weather (see FIG. 3) or with increased speed, in general.

In one or more embodiments, the system uses available data for the braking distance calculation, how data is used likely will be adjusted based on the actual data being processed. Certain data could be prioritized, such as vehicle speed. Additional data sources provide more accuracy for the estimate, when available. For example, weather condition, which could be inferred from onboard vehicle system activity (headlights, wipers, temperature sensor, etc), as well as verified with location weather data sourced from a connected network.

Algorithms for brake distance calculation can be updated as more data sources become available, such as tire temperature and wear, or infrastructure data on roadway conditions. The algorithm would incorporate factors of safety to account for data issues.

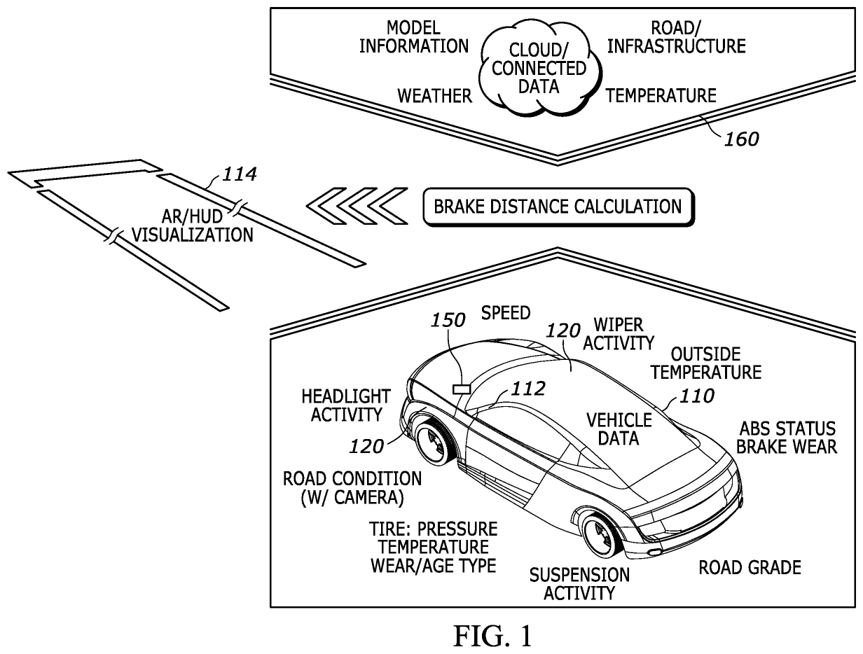

Referring to FIG. 1, the system includes vehicle onboard sensors 120 which are configured to generate vehicle real time data. The sensors include, but are not limited to sensors for detecting vehicle speed, tire type, tire condition, tire temperature, environment temperature (exterior to the vehicle), weather, road condition, road grade, and brake condition. The system further includes a connected network, such as a cloud for cloud connected data 160, configured to generate real time network data, and a processor 150 configured to estimate a stopping distance of the vehicle based on the vehicle real time data and the real time network data. The system or apparatus further includes a stopping distance indicator communicatively coupled with the processor, the stopping distance indicator configured to visualize the stopping distance to an operator of the vehicle, for example on a windshield 112 of a vehicle.

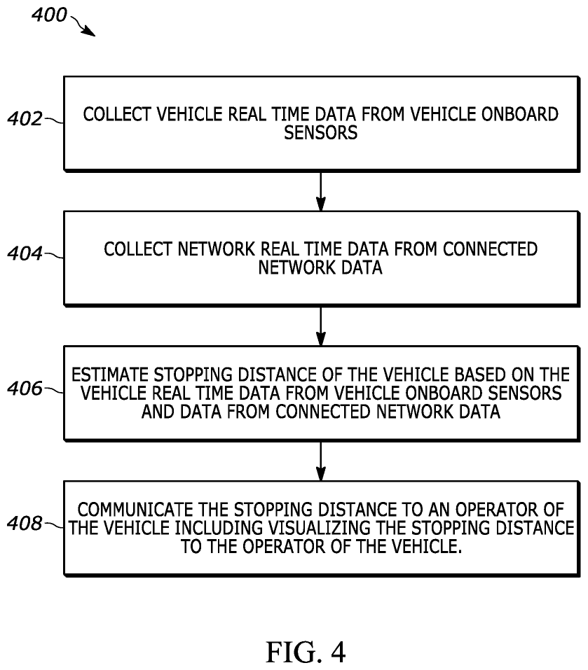

Referring to FIG. 4, a method 400 of calculating a stopping distance for a vehicle and displaying the stopping distance is described herein. The method including: collecting vehicle real time data from vehicle onboard sensors 402. One or more examples of real time data from vehicle on board sensors includes, but is not limited to The method as recited where collecting vehicle real time data from vehicle onboard sensors includes collecting vehicle speed data. The method as recited where collecting vehicle real time data from vehicle onboard sensors includes collecting tire type data. The method as recited where collecting vehicle real time data from vehicle onboard sensors includes collecting tire condition data. The method as recited where collecting vehicle real time data from vehicle onboard sensors includes collecting environmental temperature data. The method as recited where collecting vehicle real time data from vehicle onboard sensors includes collecting weather condition data. The method as recited where collecting vehicle real time data from vehicle onboard sensors includes collecting road grade data. The method as recited where collecting vehicle real time data from vehicle onboard sensors includes collecting brake condition data. Implementations of the described techniques may include hardware, a method or process, or computer software on a computer-accessible medium.

The method further includes collecting network real time data from connected network data 404. The connected network data includes, but is not limited to model information, weather, temperature, road/infrastructure information.

The method further includes estimating stopping distance of the vehicle based on the vehicle real time data from vehicle onboard sensors and data from connected network data 406. The method also includes communicating the stopping distance to an operator of the vehicle including visualizing the stopping distance to the operator of the vehicle 408. Other embodiments include corresponding computer systems, apparatus, and computer programs recorded on one or more computer storage devices, each configured to perform the actions of the methods.

Implementations may include one or more of the following features. The method as recited where visualizing the stopping distance to the operator of the vehicle includes visualizing using a heads up display (HUD). The method as recited where visualizing the stopping distance to the operator of the vehicle includes visualizing using an augmented reality heads up display (AR HUD). The method as recited where visualizing the stopping distance to the operator of the vehicle includes indicating the stopping distance with a brake box graphic. The method as recited where the brake box graphic is adjusted in real-time.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A method of calculating a stopping distance for a vehicle and displaying the stopping distance, the method comprising:
collecting vehicle real time data from vehicle onboard sensors;
collecting network real time data from connected network data;
estimating stopping distance of the vehicle based on the vehicle real time data from vehicle onboard sensors and data from connected network data; and
communicating the stopping distance to an operator of the vehicle including visualizing the stopping distance to the operator of the vehicle.

2. The method as recited in claim 1, wherein visualizing the stopping distance to the operator of the vehicle includes visualizing using a heads up display (HUD).

3. The method as recited in claim 1, wherein visualizing the stopping distance to the operator of the vehicle includes visualizing using an augmented reality heads up display (AR HUD).

4. The method as recited in claim 1, wherein visualizing the stopping distance to the operator of the vehicle includes indicating the stopping distance with a brake box graphic.

5. The method as recited in claim 4, wherein the brake box graphic is adjusted in real-time.

6. The method as recited in claim 1, wherein collecting vehicle real time data from vehicle onboard sensors includes collecting vehicle speed data.

7. The method as recited in claim 1, wherein collecting vehicle real time data from vehicle onboard sensors includes collecting tire type data.

8. The method as recited in claim 1, wherein collecting vehicle real time data from vehicle onboard sensors includes collecting tire condition data.

9. The method as recited in claim 1, wherein collecting vehicle real time data from vehicle onboard sensors includes collecting environmental temperature data.

10. The method as recited in claim 1, wherein collecting vehicle real time data from vehicle onboard sensors includes collecting weather condition data.

11. The method as recited in claim 1, wherein collecting vehicle real time data from vehicle onboard sensors includes collecting road grade data.

12. The method as recited in claim 1, wherein collecting vehicle real time data from vehicle onboard sensors includes collecting brake condition data.

13. An apparatus for calculating and displaying stopping distance for a vehicle, the apparatus comprising:
vehicle onboard sensors configured to generate vehicle real time data;
a connected network configured to generate real time network data;
a processor configured to estimate a stopping distance of the vehicle based on the vehicle real time data and the real time network data; and
a stopping distance indicator communicatively coupled with the processor, the stopping distance indicator configured to visualize the stopping distance to an operator of the vehicle.

14. The apparatus as recited in claim 13, wherein the vehicle real time data includes vehicle speed data.

15. The apparatus as recited in claim 13, wherein the vehicle real time data includes at least one of tire condition data, tire type data, or road grade data.

16. The apparatus as recited in claim 13, wherein the vehicle real time data includes at least one of environmental temperature data or weather condition data.

17. The apparatus as recited in claim 13, wherein the vehicle real time data includes brake condition data.
